(19) United States
(12) Patent Application Publication
(10) Pub. No.: US 2013/0221172 A1
(43) Pub. Date: Aug. 29, 2013

(54) HANGING APPARATUS AND METHOD OF USE

(71) Applicants: Michael Owen, South Lake Tahoe, CA (US); Steven Caliger, Reno, NV (US)

(72) Inventors: Michael Owen, South Lake Tahoe, CA (US); Steven Caliger, Reno, NV (US)

(21) Appl. No.: 13/670,309

(22) Filed: Nov. 6, 2012

Related U.S. Application Data
(63) Continuation-in-part of application No. 13/404,529, filed on Feb. 24, 2012.

(51) Int. Cl. F16M 13/02

(52) U.S. Cl. CPC F16M 13/02
USPC 248/205.3; 248/200; 248/309.1; 248/314

(57) ABSTRACT

Hanging or suspending apparatus and methods of use. The apparatus can include a strip having at least one mounting depression penetrating a mounting portion of the strip. In one embodiment, the mounting depression accommodates a hanger end or hook. Some embodiments include a strip body section with a series of hanger end mounting depressions on one or more upper surfaces of the body section. Adhesive or mounting tape may be mounted or secured to one or more surfaces of the strip body section. Some embodiments may be mounted adjacent the top edge of a door frame, wall section, or other structure. The hanging apparatus may be used to hang a variety of items, and in a particular application to hang clothing or other hangars.

### CROSS-REFERENCE TO RELATED APPLICATION

The present nonprovisional application is a continuation-in-part of Applicant Owens' prior nonprovisional patent application entitled HANGER STATION, Ser. No. 13/404,529, filed Feb. 24, 2012, which prior nonprovisional patent application is hereby incorporated by reference in its entirety. In then event of any inconsistency between such prior nonprovisional patent application and the present nonprovisional application (including without limitation any limiting aspects), the present nonprovisional application shall prevail.

### TECHNICAL FIELD

The present disclosure is directed to hanging apparatus and methods of use, and more particularly in some embodiments to hangar apparatus mountable over a door frame and the like, and methods of use.

### BACKGROUND/PROBLEMS DISCOVERED & SOLVED BY APPLICANT

Commonly, clothes are hung in closets or stored in chests of drawers. For a variety of reasons, however, clothes are also hung by clothes hangars from the upper edge of a door frame or the edge of a closet shelf. This is often done temporarily or for an extended period of time. Doing so can:
(i) allow wet or damp clothes to dry more readily, such as, for example, delicate items that are preferably not put into a dryer;
(ii) provide the ability to compare and contrast different clothing during clothing selection;
(iii) provide additional clothes hanging capacity when clothes hanging or storage space is in short supply relative to the volume of clothes kept in the home; and
(iv) allow quick hanging of clothing in an easily accessible location, possibly during packing of clothing for a trip or as a temporary suspension location for later insertion into a closet or other less visible storage location.

Hanging hangers on door frames and similar structures has long been particularly helpful where storage space is at a premium, such as in smaller bedrooms, apartments, or other housing.

Hanging things from a doorway or similar location can present problems however. For example, people or pet animals walking through or by the doorway may brush up against a hanging item and cause it to fall to the floor. Wind blowing by the hanging item can lead to the same result. For clothing, this can require that the clothing be washed or ironed again.

Further, hanger tips hung on the door frame can scratch and gouge the door frame, particularly when heavier items are hung on the frame or as hung items are knocked down and the hanger tips scratch the frame during the fall. Over time, the damage to the door frame can be substantial.

One prior art approach has been to mount hooks in or above the door frame. The hooks are mounted to that location with one or more screws, nails, or adhesive. Some hook assemblies provide a series of hooks extending from a strip mounted to the door frame or adjacent wall. Hooks are quite unattractive, however. Further, mounting one or more hooks to the frame or adjacent wall typically leaves the wall damaged in the event of removal of the hook(s). Replacement of damaged hooks can also result in damaging the wall.

Another prior art approach consists of a plastic strip with a planar base and a lip extending upwardly from, and at an acute angle to, the plane of the base. The base is mounted on the top of the doorframe by two-sided adhesive tape mounted on the bottom side of the base. The base is mounted with the angled lip distal from the adjacent wall and extending outwardly away from the wall and door frame. The lip is also heavily contoured to provide a traditional appearance and hopefully mate with more traditionally contoured door frames.

This plastic strip prior art is unattractive when used with door frames that do not provide a complimentary external contour. Also, the outwardly extending lip projects outwardly into the room, attracting attention to the outwardly and upwardly projecting lip. Objects or tall persons moving the lip can bump into it.

The plastic strip prior art also does not provide a secure hang tip mounting location so that the hangars will not slide around to undesired locations on the strip or completely off one of the opposed open ends of the strip. People, animals, or wind passing by can thus move the hangars around in undesired ways, which can lead to problems such as noted above.

Further, removal of the hangar from the strip prior art typically requires the user to lift the hangar an inch or more, and then laterally outwardly over the upwardly extending lip, in order to clear the lip of the strip. Doing so can be difficult for shorter people.

### SUMMARY OF ADDITIONAL ASPECTS OF THE INVENTION

The applicants believe they discovered the scope of the problems provided by the prior art as recited above.

In one aspect, the present solutions can provide a hangar strip having hangar end locating structure. The hanger strip can be mounted to a door frame (or other supporting structure) or wall or other structure, which may be adjacent a door frame (or other supporting structure). In certain embodiments, this hangar end locating structure can restrain undesired lateral movement of the hangar end with respect to the strip and adjacent structure.

In one aspect, the strip may include scoring, perforations, or other structure, which in some embodiments can allow the user to easily alter the length of the strip. In certain instances, such structure may penetrate a relatively thin strip wall.

Some embodiments of the hangar end locating structure providing a plurality of hangar end receiving cups along the strip. One design of a cup structure includes a tubular or other projection extending upwardly along the strip. Certain instances of the projection may have a circular, D-shape, or rectangular cross-section. The exterior of the projection may similarly include or provide one or more of a circular, D-shape, or rectangular cross-section.

Some embodiments may provide a strip structure with hanger end receiving depressions, slots, or channels along the upper portion of the strip. In some embodiments, the strip may include hanger end locating indicia or indicating structure. Some designs of the strip can provide a generally rectangular cross-section with the depressions penetrating an upper end of the strip. Some designs can have upper curved or other cross-sections along strip with depressions, slots, or channels penetrating such cross-sections.

Certain instances can provide a wall abutting strip with hangar end receiving structure extending from the wall abutting strip. Some embodiments can include a door frame mounting strip with the hangar end receiving structure extending upwardly from the door frame mounting strip. In some embodiments, the wall abutting strip can have a greater height than the hanger end receiving structure. One aspect of such a higher strip height is it can protect structure, such as an adjacent room wall, from being impacted by hangar ends or portions of other things hung from the hangar end receiving structure.

In another aspect, the hangar strip can include a decorative or other wall spaced from the portion of the strip closest to an adjacent wall when mounted to or adjacent a door frame, wall, or other structure. In some embodiments, the spaced wall may include hanger end locating indicia or indicating structure.

Another aspect provides a lightweight, resilient hangar mounting strip mountable to a wall. The mounting strip may be made of resilient material such as plastic.

Certain embodiments include wall mounting tape or other adhesive mounted or mountable to one side of the strip. In some embodiments, the hangar mounting tape or adhesive may be mounted or mountable to one or more sides or portions of the hanger. One strip design includes an upwardly extending side mountable to a wall and a lower extending side mountable to an upper surface of a structure, such as the upper edge of a door frame for example. This and other strip designs such as disclosed herein may also include upper sides mountable to structure such as a ceiling or bottom side of a shelf for example.

Yet a further aspect provides an easily moldable integrated strip body. In certain instances, the strip body consists of plastic. In some embodiments this plastic is an economical yet durable plastic, such as polyethylene for example. The strip body or at least a portion of a strip body may be paintable, translucent, and/or transparent. Alternatively, the strip body may include or consist of colored plastic.

In some embodiments, the hanger end mounting strip is sized so that multiple strips are mountable adjacent each other. Some designs of the strip can be easily and economically manufactured, packaged, shipped, unpackaged, installed, and used.

In one aspect, the hanger mounting strip is sized so that it does not extend further from the wall than a door frame. In at least some such instances, the hanger mounting strip has a low profile and is unobtrusive.

Methods of use of a hanger end mounting strip include mounting one or more strips on a structure with adhesive or one or more fasteners. Subsequently, the same person or another can then mount one or more hanger ends in one or more depressions, channels, slots, or other hanger end locating or restraining structure in the one or more mounting strips. The method can also include locating hanger end mounting indicia or indicating structure on the one or more strips.

Methods of use can also include adjusting the size of one or more mounting strips. In some embodiments, this can be done by bending the strip back and forth along a score line, perforations, or other breakable aspect of the strip.

There are other novel aspects, features, advantages, and methods of use of embodiments disclosed in the present specification. They will become apparent as the specification proceeds. In this regard, the scope of the invention should be determined by the claims as issued and not by whether a given embodiment provides any of the features, solutions, or advantages recited above in this specification.

### BRIEF DESCRIPTION OF THE DRAWINGS

The applicants' preferred and other embodiments are shown in the accompanying drawings in which:

FIG. 1 is a perspective view of one embodiment of a hangar mounting strip having a upwardly extending wall with hangar mounting sections, each having a D-shaped cross-section, extending from the upwardly extending wall;

FIG. 2 is a perspective view of one embodiment of a hangar mounting strip having an upwardly extending wall with hangar mounting sections, each with a circular cross-section, extending from the upwardly extending wall;

FIG. 3 is an elevational view of the embodiment of FIG. 1;

FIG. 4 is a perspective view of the embodiment of FIG. 1;

FIG. 5 is a perspective view of an embodiment of a hanger mounting strip having a thickened central section intermediate a rear wall and hanger end mounting cups extending from opposing sides of the central section;

FIG. 6 is a perspective view of an embodiment of a hanger mounting strip having a central mounting block-strip with a hanger end mounting slot extending along the upper face of the block-strip;

FIG. 7 is a perspective view of an embodiment of a hanger mounting strip having a central mounting block-strip with a series of hangar mounting dimples along the upper face of the block-strip;

FIG. 8 is a perspective view of an embodiment of the left portion of a hanger strip assembly, having a hanger mounting slot along the upper face of strip;

FIG. 9 is a perspective view of an embodiment of the right portion of a hanger strip assembly, having a mating hanger mounting slot along the upper face of the strip;

FIG. 10 is a plan view of an embodiment of a hanger mounting strip having a planar horizontal lower wall and a planar vertical wall perpendicularly extending from one edge of the lower wall;

FIG. 11 is a side elevational view of the embodiment of FIG. 11;

FIG. 12 is a front elevational view of the embodiment of FIG. 12 (with this version turned around when mounted, FIG. 13 is a rear rather than a front elevational view);

FIG. 13 is a partial front elevational view of a door frame with an embodiment of a two-piece assembly of FIGS. 8 and 9 mounted to the top edge of the door frame;

FIG. 14 is a partial side elevational view of upper end the door frame with the two-piece assembly embodiment on the top edge of the door frame and abutting the wall extending above the top edge of the frame;

FIG. 15 is a photograph of a door frame with translucent plastic strips mounted to the top edge of the door frame; and

FIG. 16 is a photograph of a door frame with translucent plastic strips mounted to the top edge of the door frame.

It is to be understood that spacially-orienting terms, such as upwardly, horizontally, or vertically, are used to explain relative orientation of structures as shown in the Figures and as the structures might be used. They are not to be construed to require such an orientation in space, however.

### DETAILED DESCRIPTION

This description is not to be construed as limiting. Further, various components of embodiments disclosed herein may be mixed and matched with each other to yield further arrangements of the features disclosed herein.

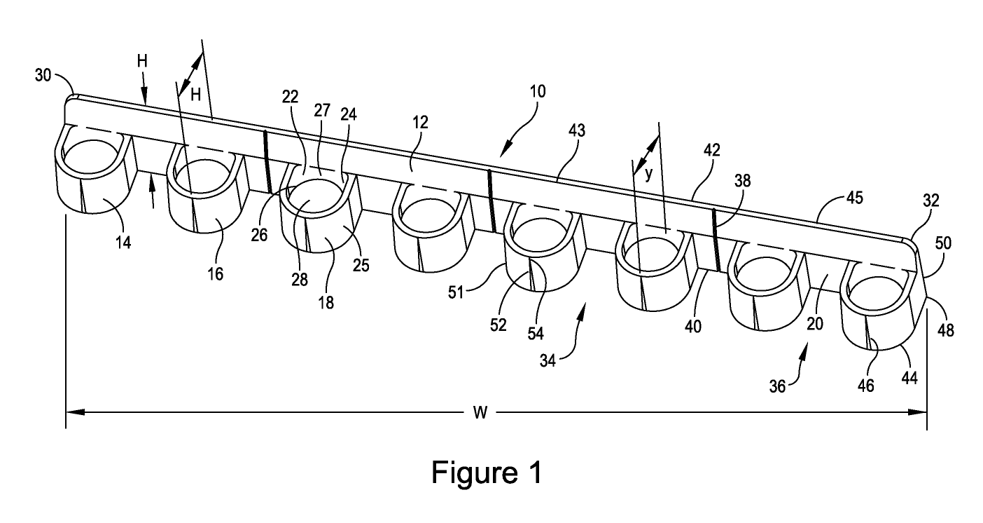

With reference now to FIG. 1, one embodiment of a hanger mounting strip, generally 10, has an upwardly extending generally planar rear wall 12 with a laterally aligned series of hanger end mounting cups, e.g., 14, 16, 18, extending transversely outwardly and forwardly from the lowermost portion 20 of the rear wall 12. The mounting cups, e.g., 18, include an interior cup channel 22 having a D-shaped cross-section 24 along its entire exterior 25 and a D-shaped cross-section in the upper portion of the interior cup channel 22. The lower end 26 of the D-shaped portion 27 terminates at a rounded dimple-like bottom end 28. Alternatively, the lower end 26 of the D-shaped portion 27 can terminate in a D-shaped planar bottom (not shown) in the cup channel 22.

In the embodiment of FIG. 1, the rear wall 12 has rounded upper opposed ends 30, 32 and eight mounting cups, e.g., 18. Between each adjacent pair of cups, e.g., 34, 36, a depression or slot, e.g., 18, penetrates the surface of the generally planar rear wall 12 and extends vertically from the bottom edge 40 to the top edge 42 of the wall 12. When desired, the user may break or separate the rear wall 12, at and long the length of the slot 18, by bending back forth around the slot 18 the opposed laterally opposed wall portions 43, 45 abutting the opposed lateral sides of the slot 18.

The bottom 44 of each mounting cup, e.g., 46, is planar. The planar bottom 44 is coterminous and coplanar with the adjacent lower edge 48 of the adjacent wall portion 50.

One or more mounting cups, e.g., 51, may have arrow indicia 52 or an integrally formed arrow-shaped depression in the front edge 54 of the cup, e.g., 18. These indicia or depressions, e.g., 52, identify the center of the mounting cup, 51, into which a user should insert a hanger end or other structure to be hung from the strip 10.

Adhesive can be applied to the backside (not shown) of the rear wall 12 in order to mount the rear wall 12 to a structure (not shown in FIG. 1), such as a wall or other structure. Mounting adhesive could also, or in the alternative, be applied to the planar bottom (not shown) of one or more of the mounting cups, e.g., 18, to do similarly. One type of adhesive that may be used is two sided tape cut to the desired shape. One such shape could be the shape of all or a portion of the backside of the rear wall 12, or the shape of some or all of a portion of the planar bottom of a mounting cup, e.g., 18.

Alternatively, the mounting strip 10 may be mounted to a structure by means of fasteners. For example, self-tapping screws (not shown) can penetrate the rear wall 12 to secure the rear wall 12 to an abutting structure such as a house wall or other structure.

The mounting strip 10 (and all others described in this specification) may, if desired, be molded, thus providing an integral strip 10 structure less the adhesive or fasteners. The mounting strip 10 thus may be made of a moldable resilient and durable material.

On such material is polyethylene. This material can be translucent, rendering the strip 10 (and all others herein) relatively unobtrusive when mounted over a door frame for example. This material is lightweight, inexpensive, and paintable. The material can, for example, be painted or otherwise colored if desired in order to, for example, match the color of adjacent structure.

The mounting strip 10 may be sized any number of ways and have differing numbers of mounting cups, e.g., 18. The rear wall 12 may be sized differently with respect to the height of the mounting cups, e.g., 18, and so for example the rear wall 12 could be the same height as the mounting cups, e.g., 18. In this regard, however, having a rear wall that is higher than the height of the mounting cups, e.g., 18, can provide a protective barrier for adjacent structure such as the room wall extending above a door frame for example. Hanger tips being mounted into, or removed from, a cup, e.g., 18, are less likely to make contact with the room wall by reason of that protective barrier.

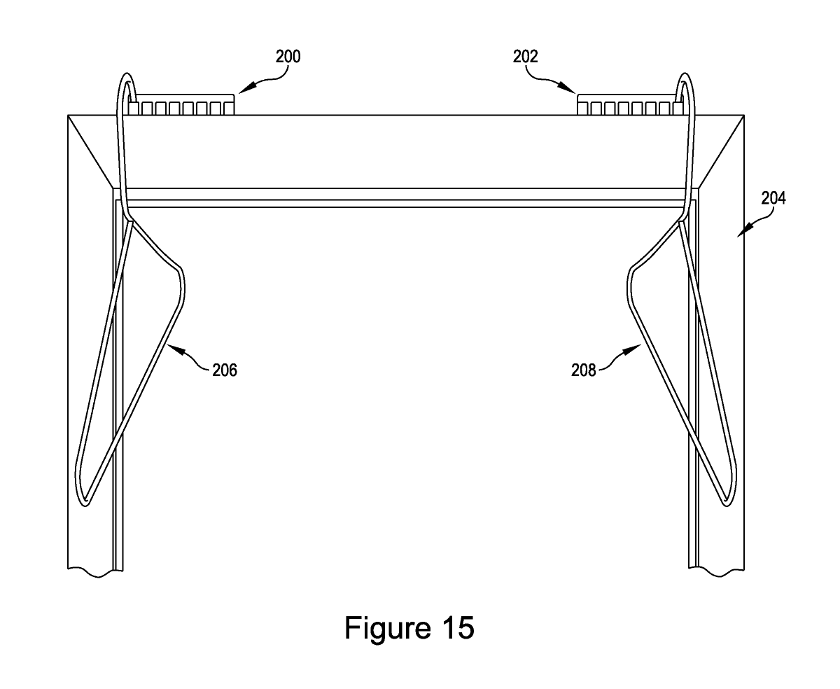

With reference now to FIGS. 1 and 15, one example 200 of a mounting strip 10 is 6 inches wide W, by 0.5270 inches deep X, by 0.5435 inches high H. Mounting cup depth Y is 0.3640 inches. This particular embodiment of mounting strip 10 is made of polyethylene and weights only 30 grams. These numbers may increase or decrease as desired, but exemplary changes in these numbers are plus or minus 10%, plus or minus 25% and plus or minus 50%.

Two such mounting strips 200, 202 are mounted, laterally spaced from each other, to the top of a door frame 204 by means of two-sided tape secured to the bottom side of the strips 200, 202 and mating upper edge of the door frame 204. Hangars 206, 208 hang from the mounting strips 200, 202 respectively. The mounting strips 200, 202 provide a very low profile and, due to their translucence, barely visible and unobtrusive structures over the top edge of the door frame.

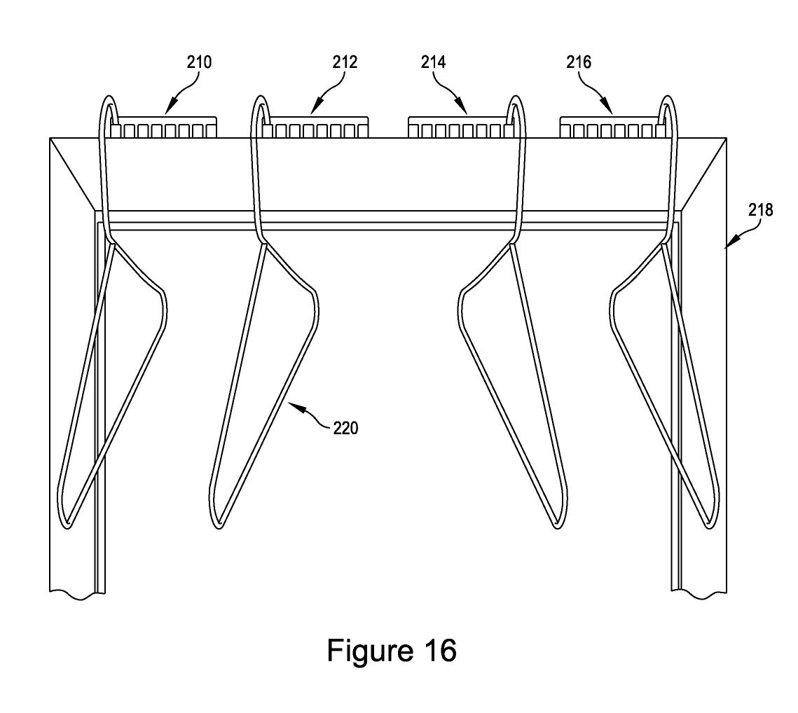

With reference now to FIG. 16, four such mounting strips 210, 212, 214, 216 are mounted to abut the top edge of a door frame 218. Hangers, e.g., 220, hang from each such mounting strip, e.g., 210. The mounting strips 210, 212, 214, 216 similarly provide a very low profile and, due to their translucence, barely visible and unobtrusive structures over the top edge of the door frame. The amount of hangar hanging capacity is greatly increased by using these unobtrusive, economical, reliable, and durable mounting strips.

In this regard, the mounting strips, e.g., 210, can be readily removable and storable for later use, without damaging any associated structure. This can be accomplished by selecting an easily removed adhesive, such as rubber cement, or suitable two-sided tape with an adhesion strength that allows the two-sided tape to be readily removed from the door frame and/or the mounting strips, e.g., 210. Conversely, use of stronger adhesive or tape can provide a more secure and more permanent bond between the mounting strips, e.g., 210, and door frame.

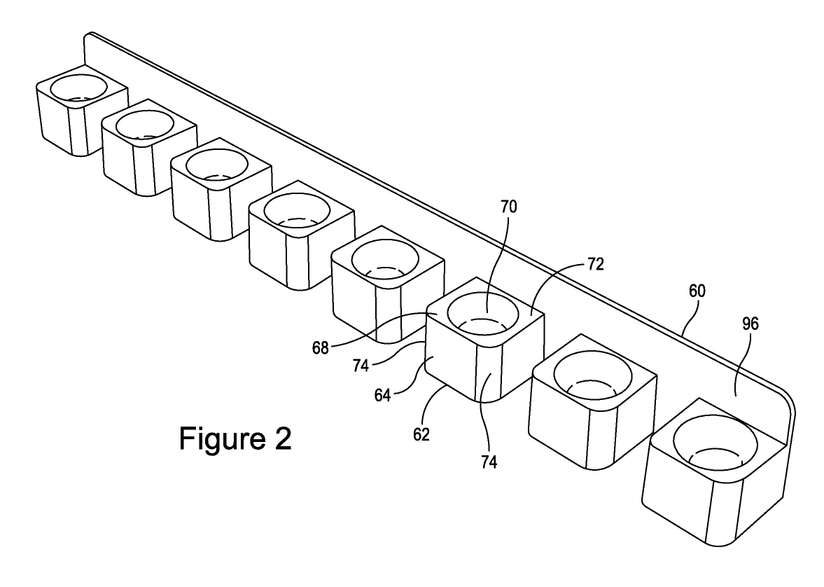

With reference now to FIG. 2, an alternative embodiment of a mounting strip 60 has mounting cups, e.g., 62, each having a vertically extending body 64. The vertically extending body 64 has a planar bottom side (not shown) opposite a top side 68 with a cup-shaped depression 70 penetrating an otherwise planar upper side 72 on the vertically extending body 64. A generally rectangular exterior periphery 74, with radiused (rounded) vertically extending corners, e.g., 76, extends from the top side 68 to the bottom side of the vertically extending body 64.

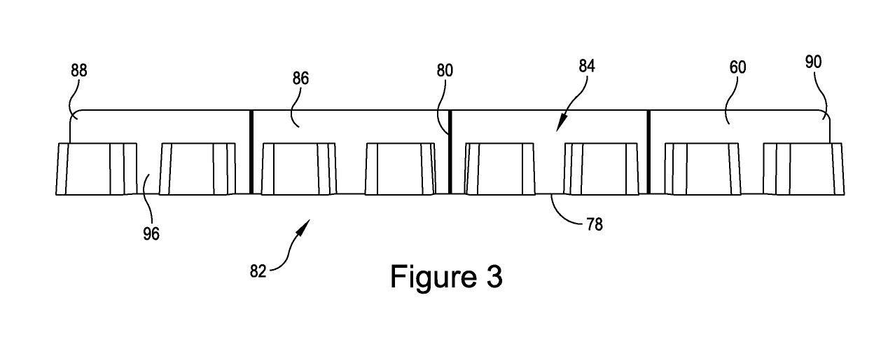

Referring now to FIG. 3, the mounting strip 60 has a planar lower side 78 and three vertically extending wall breaking slots, e.g., 80, between each of opposed mounting cup pairs, e.g., 82, 84. The vertically extending planar rear wall 86 also may have contoured, and in this case rounded, opposed upper ends 88, 90.

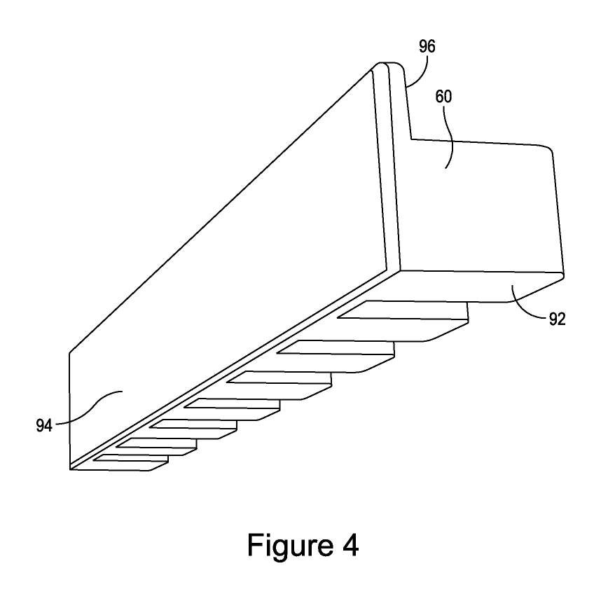

With reference now to FIG. 4, the bottom side 92 of the mounting strip 60 is planar. Two-sided tape 94 is mounted to the planar back side (not shown) of the rear, vertically extending wall 96 of the strip 60.

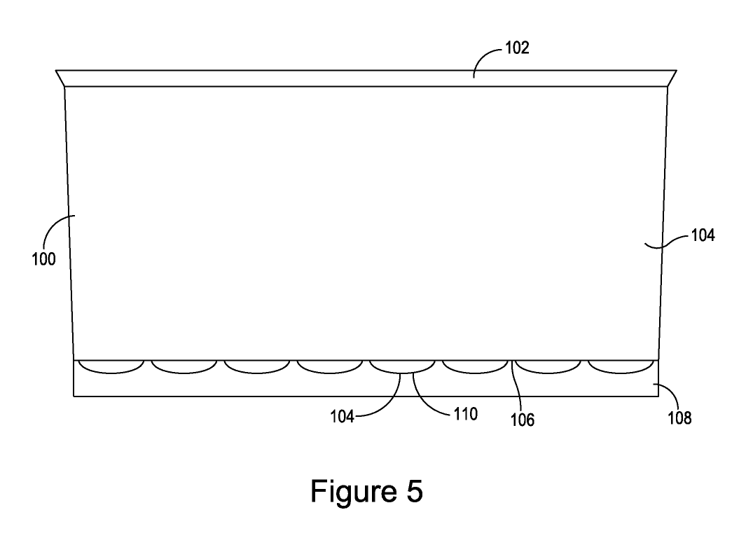

Referring now to FIG. 5, an alternative embodiment of a mounting strip 100 has a vertical rear wall 102, with a central thickened section or rectangular block 14 extending transversely from the rear wall 102. Vertically extending mounting cups, e.g., 104, extend laterally forward and outwardly from the front vertical planar side 106 of the central rectangular block 104. A planar lower side 108 extends laterally and transversely from the vertical planar side 106 and abuts and extends from the bottom ends, e.g., 110 of the cups, e.g., 104.

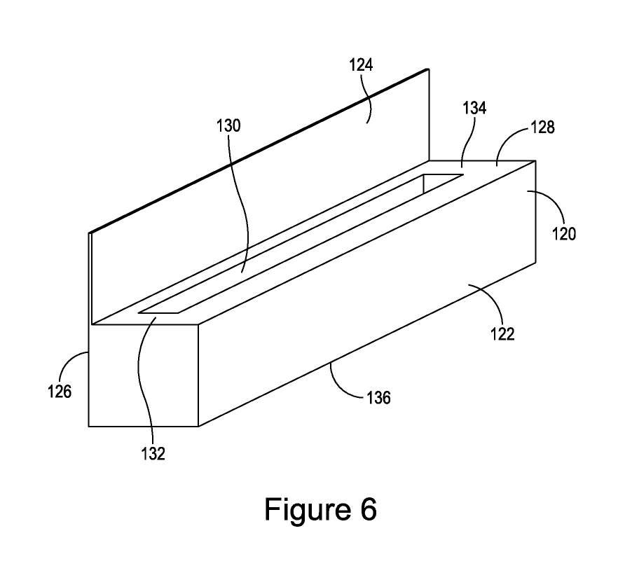

With reference now to FIG. 6, another embodiment of a mounting strip 120 has a laterally extending generally rectangular block body section 122. An optional rear wall 124 extends vertically upwardly from the backside 126 of the block body section 122. The top face or side 128 of the block body section 122 has a hanger end mounting slot or depression 130 extending laterally from one end 132 to the other opposed end 134 of the block body section 122. The mounting slot 130 has a semi-circular cross-section. The bottom face or side (not shown but indicated by 136) is planar.

Adhesive, or two-sided tape, may be applied to, for example, the bottom face or backside 136 of the mounting strip 120. In addition or in the alternative, one or more fasteners may be used to secure the mounting strip 120 in position with respect to adjacent structure. For example, such fastener(s) may penetrate the rear wall 124 and structure abutting the backside 126 of the rear wall 124.

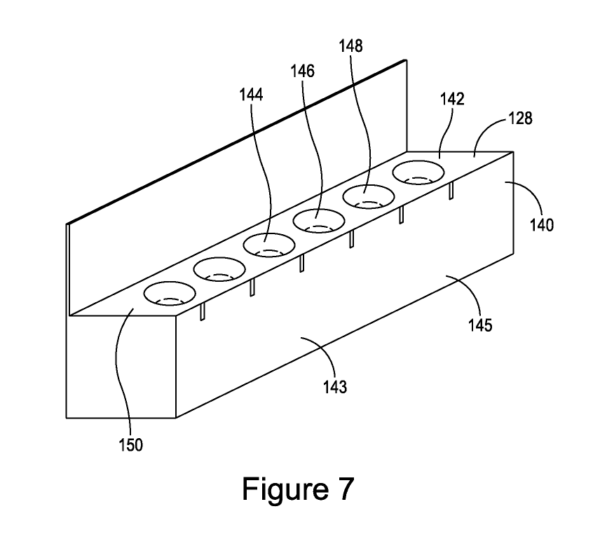

With reference now to FIG. 7, another embodiment of a mounting strip 140 has a generally planar upper mounting strip side 142 of the body block section 143 with a series of hangar mounting depressions or dimples, e.g., 144, 146, 148, extending laterally from one end 150 to the opposed end 152 of the laterally extending body block section 122. The cross-section of the mounting dimples, e.g., 144, 146, 148, can be semi-circular, V-shaped, U-shaped, or otherwise arcuate.

The front side 145 of the body block section 143 is also generally planar. Alternatively, for example, the front side could be contoured in various ways. The contour could provide, for example, a curved or arc cross-section. The curve could be vertical at the lower end of the front side and curve or arc upwardly to a horizontal upper end which could then terminate in the upper co-planar mounting strip side 142.

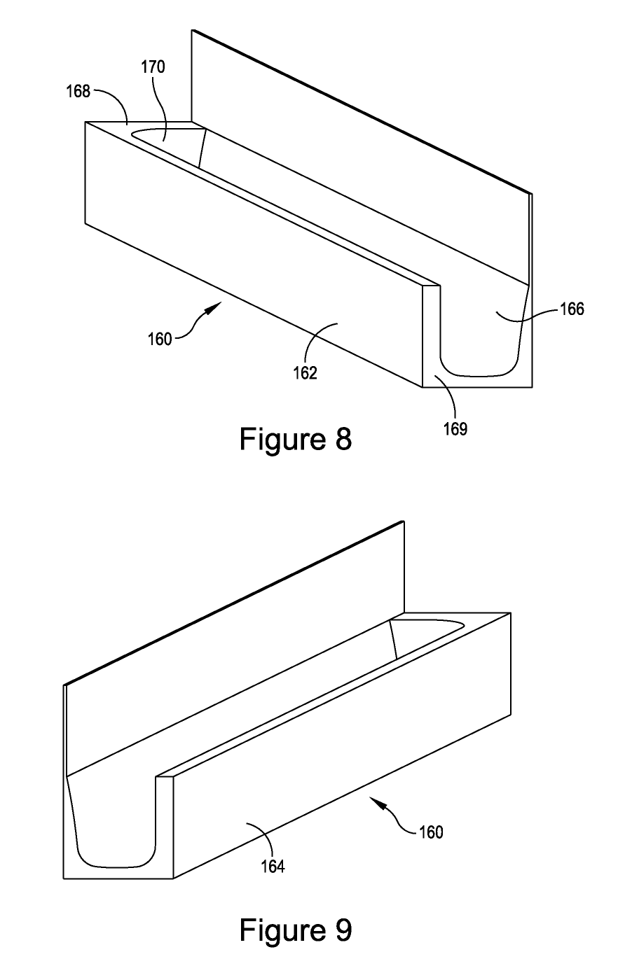

With reference now to FIGS. 8 and 9, an alternative two-piece mounting strip assembly, generally 160, has a left side mounting strip section 162 and a right side mounting strip section 164. The left strip section 162 has an internal hanger end mounting channel 166 extending laterally from one end 168 to the opposing end 170 of the strip section 164. The left end 168 of the channel 166 terminates in a vertically extending wall 170, capping the end of the channel 166 and thereby preventing a hanger end (or other supported structure if not a hanger, not shown) from sliding out of the channel 166. The right end 169 of the channel is not capped and is open. The cross-section of the channel 166 is U-shaped but could be shaped otherwise, such as V shaped or otherwise arcuate.

The structure of the right strip section 164 is the mirror image of the left strip section 162. Thus, when mounted to abut each other, the single assembly (160, not shown assembled) provides a single hanger end mounting channel running laterally through the assembly from one end to the other.

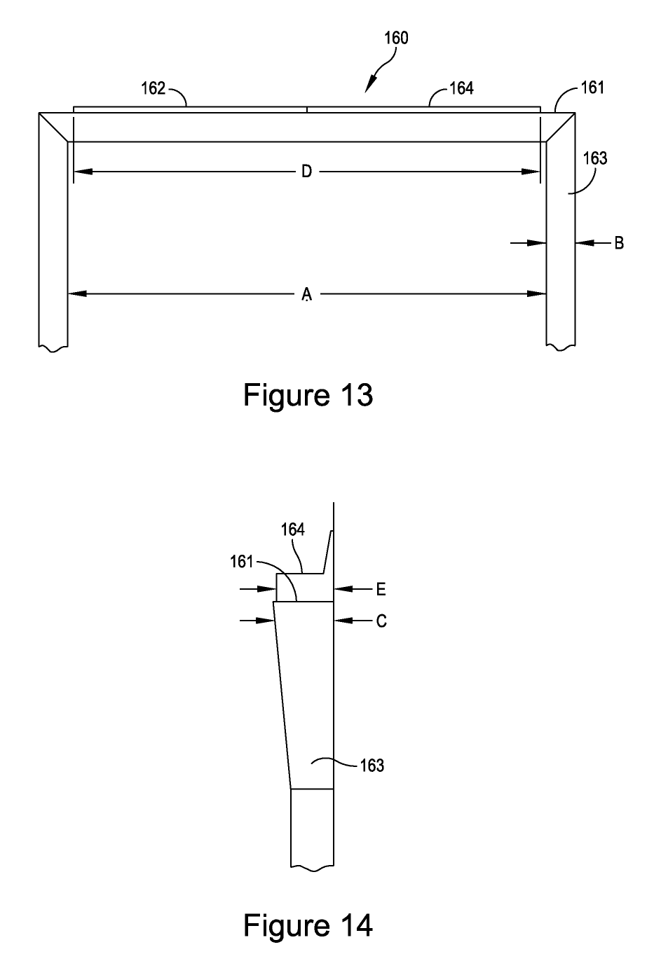

With reference now to FIGS. 13 and 14, the two-piece assembly 160 may be sized to mount it to abut the top edge 161 of a door frame 163. One common interior dimension A of a door frame 163 is 28 to 32 inches. A common width B of the frame itself is 2-4 inches. A common maximum thickness of a door frame at its upper edge is about 0.6 inches or more. These dimensions are only typical; door frames often have substantially different dimensions, however. The two-piece assembly 160 can have a total length D of 28 inches, with each mounting strip section 162, 164 being 14 inches in length. The depth E of the two-piece assembly is less than 0.6 inches, and in one embodiment, its depth is as described above for the embodiment shown in FIGS. 15 and 16 (described above).

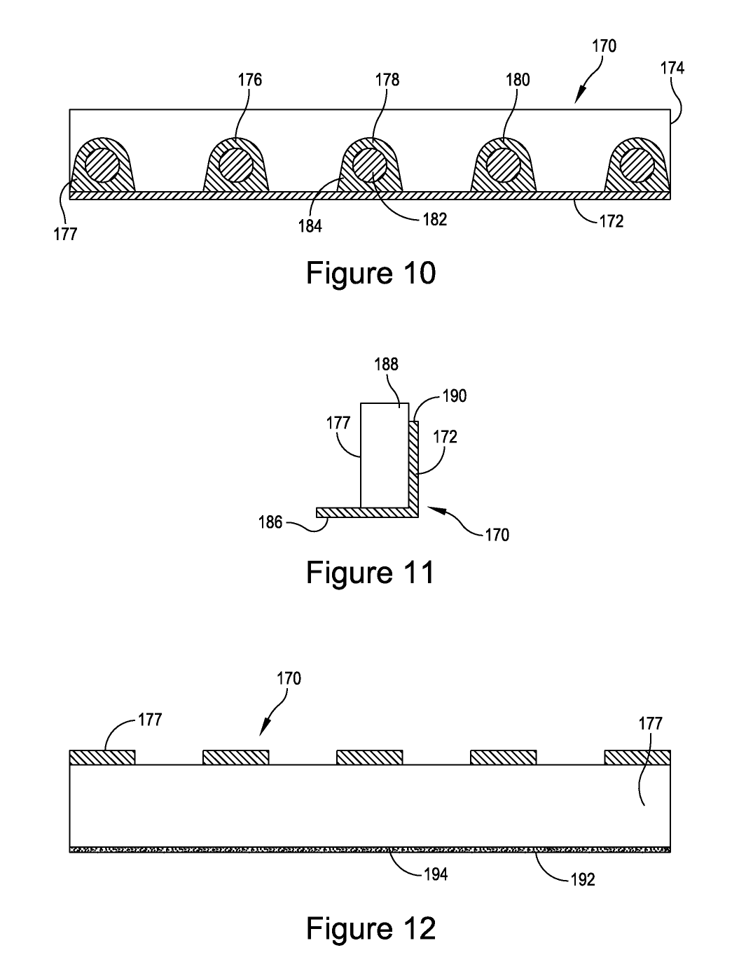

With reference now to FIG. 10, an alternative embodiment of an integral, plastic mounting strip 170 has a laterally extending planar side wall 172 and a laterally extending planar bottom wall 174 extending transversely from the lower edge (not shown in FIG. 11) the side wall. A series of hangar end mounting cups, e.g., 176, 178, 180, extend from both the planar side wall 172 and the planar bottom wall 174. Each of the mounting cups, e.g., 178, includes a hanger end mounting depression or dimple 182 in the upper end, e.g., 184, of the mounting cup 178. The dimple 182 has a semi-circular, V-shaped, U-shaped, or other arcuate cross-sectional shape.

Referring now to FIG. 11, the mounting strip 170 can provide a bottom wall edge 186 abuttable, if desired, with a vertical wall (not shown in FIG. 11). If desired, the vertical side wall 172 can then be spaced from the vertical and provide an aesthetic front cover 172, hiding most of the associated mounting cups, e.g., 177, behind the cover 172. In the embodiment of FIG. 12, the upper ends, e.g., 188, of the cups, e.g., 177, extend somewhat above the upper edge 190 of the front cover wall 172. The user can thus observe the upper end 188 in order to mount something, such as a hanger end, in the cups, e.g., 177. With reference to FIG. 12, the mounting strip 170 can have adhesive 192, such as two-sided mounting tape for example, applied to the bottom side 194 of the mounting strip.

Alternatively, the cups, e.g., 177, may be shorter in height so that they, for example, do not extend past or above the upper edge 190 of the cover 177. Indicia (not shown) or indicating structure, such as an arrow depression or slot, can be added to the front cover in order to indicate to the user the location of the cups, e.g., 177. Such indicia or indicating structure may also be included with the structure as shown in FIGS. 10-12.

One method of use of a mounting strip includes:
A. mounting one or more strips on a structure (such as directly above a door frame, abutting the top edge of the door frame) with adhesive or one or more fasteners;
B. the same person or another can then mount one or more hanger ends in one or more depressions, channels, slots, or other hanger end locating or restraining structure in the one or more mounting strips;
C. removing the hanger end by grasping a portion of the hanger and lifting it slightly in order to lift the hanger end out of the hanger end locating or restraining structure; and
D. moving the hanger and hanger end laterally away from the mounting strip. The method can also include, during or before step B, locating hanger end mounting indicia or indicating structure on the one or more strips.

Methods of use can also include adjusting the size of one or more mounting strips. In some embodiments, this can be done by bending the strip back and forth along a score line or slot, serial perforations, or other breakable aspect of the strip. In other embodiments, this can be done by cutting the strip with a suitable saw or other cutting tool or, in the case of plastic mounting strip components or bodies, suitable heating tools.

Methods of use can include mounting one or more mounting strips to the upper surface or edge of door frames, shelves, or other structures and/or associated or other areas of a wall. For example, the mounting strip could be mounted to a wall without an underlying door frame and allow mounting of hangars or other components in the mounting strip.

1. A mounting strip comprising in combination:
A. a strip body; and
B. a plurality of mounting depressions penetrating one or more surfaces in the strip body.

2. The mounting strip of claim 1 wherein the strip body comprises a planar wall section having a plurality of hangar end mounting projections extending from the planar wall section, and wherein each hanger end mounting depression penetrates an upper surface in an associated hangar end mounting projection.

3. The mounting strip of claim 2 wherein each of the hangar end mounting projections comprises a cupping section including a hanger mounting depression within the cupping section.

4. The mounting strip of claim 3 wherein each cupping section has a bottom portion with an arcuate cross-section.

5. The mounting strip of claim 1 wherein the strip body is an integral, one piece structure.

6. The mounting strip of claim 4 wherein the strip body in an integral, one piece structure.

7. The mounting strip of claim 1 further comprising adhesive secured to an external surface on the strip body.

8. The mounting strip of claim 6 further comprising two sided adhesive tape secured to an external surface of the strip body.

9. The mounting strip of claim 1 wherein the strip body consists essentially of resilient plastic.

10. The mounting strip of claim 5 wherein the strip body consists essentially of resilient plastic.

11. The mounting strip of claim 6 wherein the strip body consists essentially of resilient plastic.

12. The mounting strip of claim 7 wherein the strip body consists essentially of resilient plastic.

13. The mounting strip of claim 8 wherein the strip body consists essentially of translucent resilient plastic.

14. The mounting strip of claim 9 wherein the strip body consists essentially of resilient plastic.

15. The mounting strip of claim 1 further comprising one or more breakable slotted sections in the strip body, with at least one breakable slotted section intermediate two adjacent mounting depressions.

16. The mounting strip of claim 2 further comprising one or more breakable slotted sections penetrating the strip body, with at least one breakable slotted section intermediate two adjacent mounting depressions.

17. The mounting strip of claim 14 further comprising one or more breakable slotted sections penetrating the strip body, with at least one breakable slotted section intermediate two adjacent mounting depressions.

18. The mounting strip of claim 1 wherein the strip body has depth, from a front side to back sides of the mounting strip, of less than 0.6 inches.

19. The mounting strip of claim 15 wherein the strip body has depth, from a front side to back sides of the mounting strip, of less than 0.6 inches.

20. The mounting strip of claim 17 wherein the strip body has depth, from a front side to back sides of the mounting strip, of less than 0.6 inches.
